(19) United States
(12) Patent Application Publication
(10) Pub. No.: US 2020/0188960 A1
(43) Pub. Date: Jun. 18, 2020

(54) Automatic Conveying and Sorting Workbench based on Photoelectric Sensing Judgment and Classification

(71) Applicant: Hoi Yan LEE, Hong Kong (HK)

(72) Inventor: Hoi Yan LEE, Hong Kong (HK)

(21) Appl. No.: 16/248,753

(22) Filed: Jan. 15, 2019

(30) Foreign Application Priority Data
Dec. 17, 2018 (CN) 201811539828.9

(51) Int. Cl. B07C 5/10; B07C 5/36

(52) U.S. Cl. CPC B07C 5/10; B07C 5/36

(57) ABSTRACT

The invention relates to an automatic conveying and sorting workbench based on photoelectric sensing judgement and classification which includes a sorting device for sorting miniature circuit breakers, a detecting device for detecting types of miniature circuit breakers, a transmitting device for transmitting miniature circuit breakers, and a control device. The transmitting device includes a plurality of convey belts distributed around the sorting device. The detecting device includes a through-beam photoelectric sensor disposed at one end of one of the conveyor belts adjacent to the sorting device. The sorting device includes a pushing assembly for pushing the sorted miniature circuit breaker onto a corresponding conveyor belt, and a drive assembly for driving the rotation of the pushing assembly. The control device includes a controller. The through-beam photoelectric sensor is electrically connected to the controller. The present invention improves sorting efficiency, reduces unnecessary time costs, speeds up the completion of electrical projects, and reduces labor and labor costs.

### FIELD OF THE INVENTION

The invention relates to electrical equipment, and in particular to an automatic conveying and sorting workbench based on photoelectric sensing judgement and classification.

### BACKGROUND

In the construction of some large-scale electrical projects, some electrical cabinets and control cabinets are installed by a large number of miniature circuit breakers. The miniature circuit breakers need to be manually classified before installation. The process is slow, inefficient, and waste of unnecessary time cost, and extends the completion time of electrical projects, and takes up a lot of labor, wasting a lot of labor costs.

### SUMMARY OF THE INVENTION

The technical problem to be solved is to overcome the above-mentioned deficiency by providing an automatic conveying and sorting workbench based on photoelectric sensing judgement and classification.

To solve the above problem, the present invention provides the following the technical solution.

An automatic conveying and sorting workbench based on photoelectric sensing judgement and classification includes a sorting device for sorting miniature circuit breakers, a detecting device for detecting types of miniature circuit breakers, a transmitting device for transmitting miniature circuit breakers, and a control device. The transmitting device includes a plurality of convey belts distributed around the sorting device. The detecting device includes a through-beam photoelectric sensor disposed at one end of one of the conveyor belts adjacent to the sorting device. The sorting device includes a pushing assembly for pushing the sorted miniature circuit breaker onto a corresponding conveyor belt, and a drive assembly for driving the rotation of the pushing assembly. The control device includes a controller, and the through-beam photoelectric sensor is electrically connected to the controller.

Further, the conveyor belt corresponding to the through-beam photoelectric sensor is a first conveyor belt, and the first conveyor belt is provided with a limiting device for limiting all the miniature circuit breakers on the first conveyor belt. The sorting device further includes a second conveyor belt for transmitting a single pole miniature circuit breaker, a third conveyor belt for transmitting a two pole miniature circuit breaker, and a fourth conveyor belt for transmitting a three pole miniature circuit breaker. The conveying directions of the first conveyor belt, the second conveyor belt, the third conveyor belt and the fourth conveyor belt are all directed to the sorting device.

Further, the limiting device includes a fifth conveyor belt and a sixth conveyor belt having the same conveying direction. The fifth conveyor belt and the sixth conveyor belt are disposed directly above the first conveyor belt, and the conveying direction of the fifth conveyor belt and the sixth conveyor belt is parallel to the conveying direction of the first conveyor belt.

Further, a plurality of limiting rods disposed along the conveying direction of the first conveyor belt are disposed between the fifth conveyor belt and the sixth conveyor belt. The center lines of all the limiting rods are horizontally disposed and are perpendicular to the conveying direction of the first conveyor belt. The fifth conveyor belt is fixedly connected to the side of the first conveyor belt by two first connecting rods. The sixth conveyor belt is fixedly connected to one side of the first conveyor belt away from the first connecting rod by two second connecting rods.

Further, the sorting device includes a sorting table having a rectangular structure. The pushing assembly is disposed directly above the sorting table through a support frame. The side of the sorting table is respectively connected with the output end of the first conveyor belt, the input of the second conveyor belt, the output of the third conveyor belt, and the output of the fourth conveyor belt.

Further, the pushing assembly includes a driving cylinder and a pushing plate disposed between the sorting table and the support frame. The driving cylinder is horizontally disposed and fixedly connected to the rotating assembly through the first connecting frame. The pushing plate is fixedly connected to the output end of the driving cylinder by the second connecting frame. The bottom of the second connecting frame is slidably connected to the bottom of the first connecting frame by a sliding rail.

Further, the rotating assembly includes a vertically disposed rotating shaft and a driving motor. The top of the rotating shaft is provided with a first bevel, and an output end of the driving motor is meshed with the first bevel through a second bevel. The bottom of the rotating shaft is fixedly connected to the first connecting frame.

The technical effect of the present invention is to provide an automatic conveying and sorting workbench based on photoelectric sensing judgement and classification. The miniature circuit breakers are successively placed between the two limiting rods, and the fifth conveyor belt and the sixth conveyor belt limit the miniature circuit breakers, ensuring that the miniature circuit breakers remain in the same position through the through-beam photoelectric sensor. The data on the time transmitted by the through-beam photoelectric sensor to the controller is used to calculate the width of the miniature circuit breaker to determine the type of the miniature circuit breaker. The miniature circuit breaker falls onto the sorting table, and the controller controls the driving motor to drive the output direction of the driving cylinder in parallel to the conveying direction of the corresponding conveyor belt. The driving cylinder then drives the pushing plate to push the miniature circuit breaker to the corresponding conveyor belt, improving sorting efficiency, reducing unnecessary time costs, speeding up the completion of electrical projects, and reducing labor and labor costs.

### BRIEF DESCRIPTION OF THE DRAWINGS

The invention is illustrated by the following figures and embodiments.

FIG. 1 shows a schematic diagram of 3D structure of an automatic conveying and sorting workbench based on photoelectric sensing judgement and classification in accordance with an example embodiment.

FIG. 2 shows a schematic diagram of a first conveyor belt and a sorting device of an automatic conveying and sorting workbench based on photoelectric sensing judgement and classification in accordance with an example embodiment.

FIG. 3 shows a schematic diagram of a first conveyor belt and a through-beam photoelectric sensor of an automatic conveying and sorting workbench based on photoelectric sensing judgement and classification in accordance with an example embodiment.

FIG. 4 shows an enlarged figure of A of FIG. 3.

FIG. 5 shows a structural assembly diagram of a rotating assembly and a driving assembly of an automatic conveying and sorting workbench based on photoelectric sensing judgement and classification in accordance with an example embodiment.

The reference numbers of the figures are as follows:

1a: first conveyor belt; 1b: second conveyor belt; 1c: third conveyor belt; 1d: fourth conveyor belt; 2: sorting device; 2a: pushing assembly; 2a1: first connecting frame; 2a2: second connecting frame; 2a3: driving cylinder; 2a4: sliding rail; 2a5: pushing plate; 2b: driving assembly; 2b1: rotating shaft; 2b2: driving motor; 2c: sorting table; 2d: support frame; 3: through-beam photoelectric sensor; 4: limiting device; 4a: fifth conveyor belt; 4b: sixth conveyor belt; 4c: first connecting rod; 4d: second connecting rod; 4e: limiting rod.

### DETAILED DESCRIPTION

The invention is illustrated in accordance with figures. The figures as simplified diagrams demonstrate the basic structures of the apparatus of embodiments of the invention. Thus, the invention is not limited to the figures.

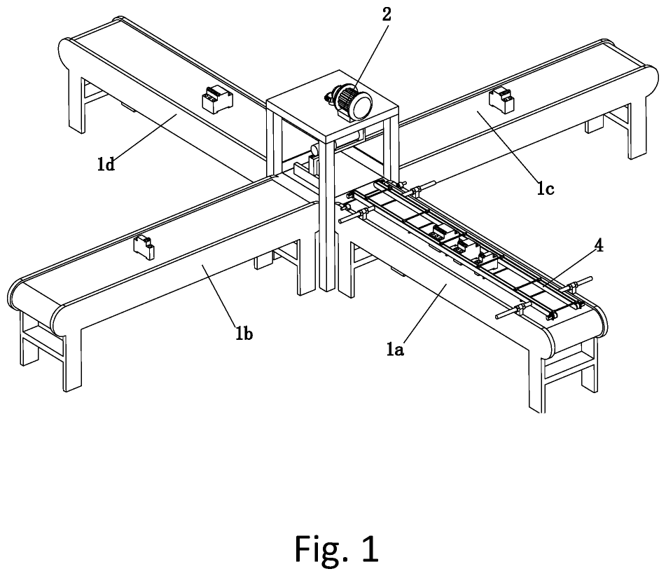

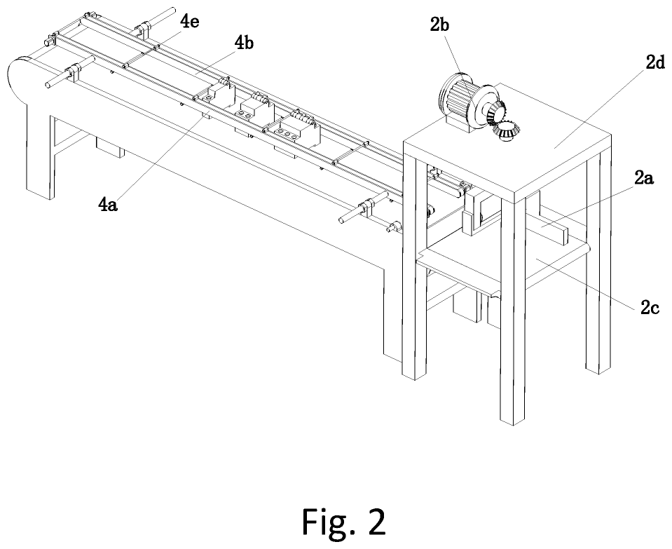

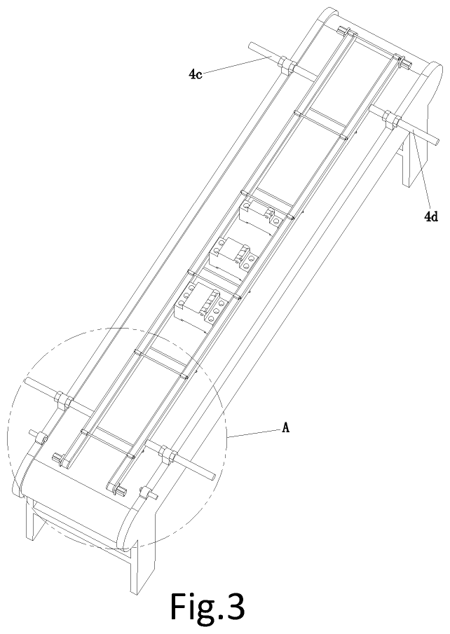

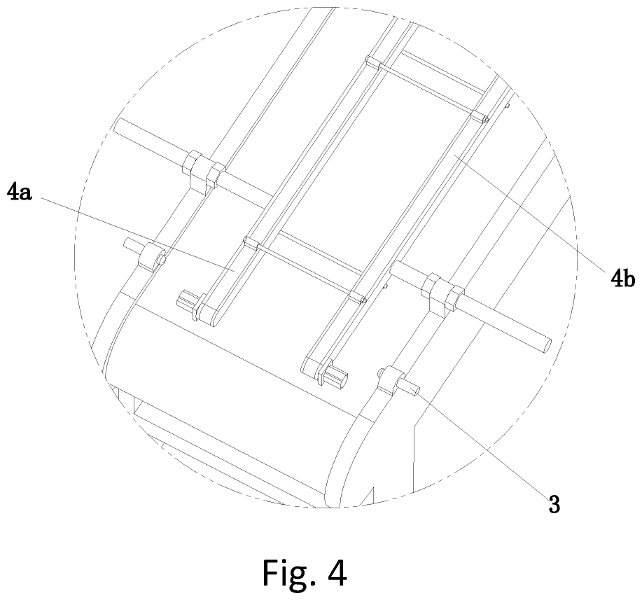

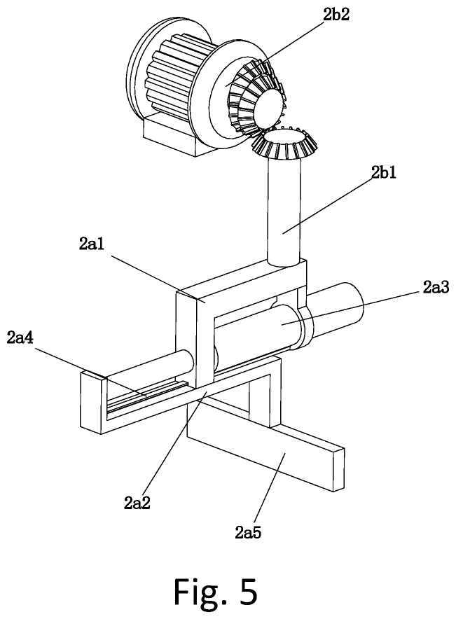

Referring to FIGS. 1-5, an automatic conveying and sorting workbench based on photoelectric sensing judgement and classification includes a sorting device 2 for sorting miniature circuit breakers, a detecting device for detecting types of miniature circuit breakers, a transmitting device for transmitting miniature circuit breakers, and a control device. The transmitting device includes a plurality of convey belts distributed around the sorting device 2. The detecting device includes a through-beam photoelectric sensor 3 disposed at one end of one of the conveyor belts adjacent to the sorting device 2. The sorting device 2 includes a pushing assembly 2a for pushing the sorted miniature circuit breaker onto a corresponding conveyor belt, and a drive assembly 2b for driving the rotation of the pushing assembly 2a. The control device includes a controller, and the through-beam photoelectric sensor 3 is electrically connected to the controller. The miniature circuit breakers are successively placed on the conveying device, ensuring that the miniature circuit breakers remain in the same position through the through-beam photoelectric sensor 3. The data on the time transmitted by the through-beam photoelectric sensor 3 to the controller is used to calculate the width of the miniature circuit breaker to determine the type of the miniature circuit breaker. The miniature circuit breaker falls onto the sorting table 2, and the controller controls the rotating assembly to drive the pushing direction of the pushing assembly 2a in parallel to the conveying direction of the corresponding conveyor belt. The pushing assembly 2a then pushes the miniature circuit breaker onto the corresponding conveyor belt.

The conveyor belt corresponding to the through-beam photoelectric sensor 3 is a first conveyor belt 1a, and the first conveyor belt 1a is provided with a limiting device 4 for limiting all the miniature circuit breakers on the first conveyor belt 1a. The sorting device 2 further includes a second conveyor belt 1b for transmitting a single pole miniature circuit breaker, a third conveyor belt 1c for transmitting a two pole miniature circuit breaker, and a fourth conveyor belt 1d for transmitting a three pole miniature circuit breaker. The conveying directions of the first conveyor belt 1a, the second conveyor belt 1b, the third conveyor belt 1c and the fourth conveyor belt 1d are all directed to the sorting device 2. The miniature circuit breakers are successively placed on the first conveyor belt 1a. The limiting device 4 ensures that the miniature circuit breakers remain in the same position through the through-beam photoelectric sensor 3. The data on the time transmitted by the through-beam photoelectric sensor 3 to the controller is used to calculate the width of the miniature circuit breaker to determine the type of the miniature circuit breaker. The miniature circuit breaker falls onto the sorting table 2, and the controller controls the rotating assembly to drive the pushing direction of the pushing assembly 2a in parallel the conveying direction of the corresponding conveyor belt. The pushing assembly 2a then pushes the miniature circuit breaker onto the corresponding conveyor belt.

The limiting device 4 includes a fifth conveyor belt 4a and a sixth conveyor belt 4b having the same conveying direction. The fifth conveyor belt 4a and the sixth conveyor belt 4b are disposed directly above the first conveyor belt 1a, and the conveying direction of the fifth conveyor belt 4a and the sixth conveyor belt 4b is parallel to the conveying direction of the first conveyor belt 1a. The miniature circuit breakers are successively placed on the first conveyor belt 1a. The fifth conveyor belt 4a and the sixth conveyor belt 4b limit the miniature circuit breakers, ensuring that the miniature circuit breakers remain in the same position through the through-beam photoelectric sensor 3.

Between the fifth conveyor belt 4a and the sixth conveyor belt 4b, a plurality of limiting rods 4e are arranged along the conveying direction of the first conveyor belt 1a. The center lines of all the limiting rods 4e are horizontally arranged and perpendicular to the conveying direction of the first conveyor belt 1a. The fifth conveyor belt 4a is fixedly connected to the side of the first conveyor belt 1a by two first connecting rods 4c, and the sixth conveyor belt 4b is fixedly connected to one side of the first conveyor belt 1a away from the first connecting rod 4c by two second connecting rods 4d. The miniature circuit breaker is successively placed between the two limiting rods 4e, and the fifth conveyor belt 4a and the sixth conveyor belt 4b limit the miniature circuit breaker to ensure the miniature circuit breakers remains in the same position through the through-beam photoelectric sensor 3.

The sorting device 2 includes a sorting table 2c having a rectangular structure. The pushing assembly 2a is disposed directly above the sorting table 2c through a support frame 2d. The side of the sorting table 2c is respectively connected with the output end of the first conveyor belt 1a, the input of the second conveyor belt 1b, the output of the third conveyor belt 1c, and the output of the fourth conveyor belt 1d. When the miniature circuit breaker is transferred to the sorting table 2c, the rotating assembly drives the pushing assembly 2a to push the miniature circuit breaker onto the corresponding conveyor belt.

The pushing assembly 2a includes a driving cylinder 2a3 and a pushing plate 2a5 disposed between the sorting table 2c and the support frame 2d. The driving cylinder 2a3 is horizontally disposed and fixedly connected to the rotating assembly through the first connecting frame 2a1. The pushing plate 2a5 is fixedly connected to the output end of the driving cylinder 2a3 by the second connecting frame 2a2. The bottom of the second connecting frame 2a2 is slidably connected to the bottom of the first connecting frame 2a1 by a sliding rail 2a4. The driving cylinder 2a3 drives the second connecting frame 2a2 to drive the pushing plate 2a5 to slide on the pushing plate 2a5 so that the miniature circuit breakers are pushed onto the designated conveyor belt.

The rotating assembly includes a vertically disposed rotating shaft 2b1 and a driving motor 2b2. The top of the rotating shaft 2b1 is provided with a first bevel, and an output end of the driving motor 2b2 is meshed with the first bevel through a second bevel. The bottom of the rotating shaft 2b1 is fixedly connected to the first connecting frame 2a1. The controller determines the type of the miniature circuit breaker, and the driving motor 2b2 drives the driving cylinder 2a3 to rotate through the rotating shaft 2b1, so that the output direction of the driving cylinder 2a3 is directed to the corresponding conveyor belt. The model of the controller and the through-beam photoelectric sensor is prior art and no longer detailed here.

The working principle: the miniature circuit breaker is successively placed between the two limiting rods 4e, and the fifth conveyor belt 4a and the sixth conveyor belt 4b limit the miniature circuit breaker to ensure the miniature circuit breakers remains in the same position through the through-beam photoelectric sensor 3. The data on the time transmitted by the through-beam photoelectric sensor 3 to the controller is used to calculate the width of the miniature circuit breaker to determine the type of the miniature circuit breaker. The miniature circuit breaker falls onto the sorting table 2, and the controller controls the rotating assembly to drive the pushing direction of the pushing assembly 2a in parallel the conveying direction of the corresponding conveyor belt. The pushing assembly 2a then pushes the miniature circuit breaker onto the corresponding conveyor belt.

The exemplary embodiments of the present invention are thus fully described. Although the description referred to particular embodiments, it will be clear to one skilled in the art that the present invention may be practiced with variations of these specific details. Hence this invention should not be construed as limited to the embodiments set forth herein.

What is claimed is:

1. An automatic conveying and sorting workbench based on photoelectric sensing judgement and classification, comprising: a sorting device 2 for sorting miniature circuit breakers, a detecting device for detecting types of miniature circuit breakers, a transmitting device for transmitting miniature circuit breakers, and a control device; wherein the transmitting device includes a plurality of convey belts distributed around the sorting device; the detecting device includes a through-beam photoelectric sensor 3 disposed at one end of one of the conveyor belts adjacent to the sorting device 2; the sorting device 2 includes a pushing assembly 2a for pushing the sorted miniature circuit breaker onto a corresponding conveyor belt, and a drive assembly 2b for driving the rotation of the pushing assembly 2a; the control device includes a controller, and the through-beam photoelectric sensor is electrically connected to the controller,
wherein the conveyor belt corresponding to the through-beam photoelectric sensor 3 is a first conveyor belt 1a, and the first conveyor belt 1a is provided with a limiting device 4 for limiting all the miniature circuit breakers on the first conveyor belt 1a; the sorting device 2 further includes a second conveyor belt 1b for transmitting a single pole miniature circuit breaker, a third conveyor belt 1c for transmitting a two pole miniature circuit breaker, and a fourth conveyor belt 1d for transmitting a three pole miniature circuit breaker; the conveying directions of the first conveyor belt 1a, the second conveyor belt 1b, the third conveyor belt 1c and the fourth conveyor belt 1d are all directed to the sorting device 2; the limiting device 4 includes a fifth conveyor belt 4a and a sixth conveyor belt 4b having the same conveying direction; the fifth conveyor belt 4a and the sixth conveyor belt 4b are disposed directly above the first conveyor belt 1a, and the conveying direction of the fifth conveyor belt 4a and the sixth conveyor belt 4b is parallel to the conveying direction of the first conveyor belt,
wherein a plurality of limiting rods 4e disposed along the conveying direction of the first conveyor belt 1a are disposed between the fifth conveyor belt 4a and the sixth conveyor belt 4b; the center lines of all the limiting rods 4e are horizontally disposed and are perpendicular to the conveying direction of the first conveyor belt 1a; the fifth conveyor belt 4a is fixedly connected to the side of the first conveyor belt 1a by two first connecting rods 4c; the sixth conveyor belt 4b is fixedly connected to one side of the first conveyor belt 1a away from the first connecting rod 4c by two second connecting rods 4d; the rotating assembly includes a vertically disposed rotating shaft 2b1 and a driving motor 2b2; the top of the rotating shaft 2b1 is provided with a first bevel, and an output end of the driving motor 2b2 is meshed with the first bevel through a second bevel; the bottom of the rotating shaft 2b1 is fixedly connected to the first connecting frame 2a1.

2. The automatic conveying and sorting workbench based on photoelectric sensing judgement and classification of claim 1, wherein the sorting device 2 includes a sorting table 2c having a rectangular structure; the pushing assembly 2a is disposed directly above the sorting table 2c through a support frame 2d; the side of the sorting table 2c is respectively connected with the output end of the first conveyor belt 1a, the input of the second conveyor belt 1b, the output of the third conveyor belt 1c, and the output of the fourth conveyor belt 1d.

3. The automatic conveying and sorting workbench based on photoelectric sensing judgement and classification of claim 2, wherein the pushing assembly 2a includes a driving cylinder 2a3 and a pushing plate 2a5 disposed between the sorting table 2c and the support frame 2d; the driving cylinder 2a3 is horizontally disposed and fixedly connected to the rotating assembly through the first connecting frame 2a1; the pushing plate 2a5 is fixedly connected to the output end of the driving cylinder 2a3 by the second connecting frame 2a2; the bottom of the second connecting frame 2a2 is slidably connected to the bottom of the first connecting frame 2a1 by a sliding rail 2a4.
